(19) United States
(12) Patent Application Publication
(10) Pub. No.: US 2026/0343381 A1
(43) Pub. Date: Oct. 29, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/110,646

(22) PCT Filed: Sep. 20, 2022
(86) PCT No.: PCT/CN2022/120046

§ 371 Date: Mar. 11, 2025

(51) Int. Cl. H04W 48/08; H04W 48/16; H04W 60/00; H04W 84/06

(52) U.S. Cl. CPC H04W 48/08; H04W 48/16; H04W 60/00; H04W 84/06

(57) ABSTRACT

Embodiments of the present disclosure provide an information processing method and apparatus, a communication device, and a storage medium. An application function network element receives capability information of a non-terrestrial network (NTN) access device, wherein the capability information is at least used for indicating a sensing capability supported by the NTN access device.

### TECHNICAL FIELD

The present disclosure relates to the field of wireless communication technology but is not limited to the field of wireless communication technology, and in particular to an information processing method and apparatus, a communication device and a storage medium.

### BACKGROUND

Wireless sensing technology aims to obtain information about remote objects and their characteristics without physically contacting the remote objects themselves. By analyzing the sensing data of the objects and their surroundings, meaningful information about the objects and their characteristics can be obtained.

The integrated sensing and communication in the 5G system specified by 3GPP (3rd Generation Partnership Project) is providing sensing capability by the 5G NR (new radio) wireless communication system and infrastructure used for communication, and the sensing information can come from RF and/or non-RF based sensors.

The non-terrestrial networks (NTN) are communication networks that use satellites or aerial vehicles to provide communication services to user equipment (UE) based on terrestrial communication networks.

In the related art, there is no solution for NTN-based sensing services in wireless communication networks.

### SUMMARY

Embodiments of the present disclosure provide an information processing method and apparatus, a communication device, and a storage medium.

A first aspect of the embodiments of the present disclosure provides an information processing method, which is executed by an application function network element, and the method includes:
receiving capability information of a non-terrestrial network (NTN) access device; wherein the capability information is at least used to indicate a sensing capability supported by the NTN access device.

A second aspect of the embodiments of the present disclosure provides an information processing method, which is executed by a non-terrestrial network (NTN) access device, and the method includes:
sending capability information of the NTN access device to an application function network element; wherein the capability information is at least used to indicate a sensing capability supported by the NTN access device.

A third aspect of the embodiments of the present disclosure provides an information processing apparatus, which is applied to an application function network element, and the apparatus includes:
a receiving module, configured to receive capability information of a non-terrestrial network (NTN) access device; wherein the capability information is at least used to indicate a sensing capability supported by the NTN access device.

A fourth aspect of the embodiments of the present disclosure provides an information processing apparatus, which is applied to a non-terrestrial network (NTN) access device, and the apparatus includes:
a sending module, configured to send capability information of the NTN access device to an application function network element; wherein the capability information is at least used to indicate a sensing capability supported by the NTN access device.

A fifth aspect of an embodiment of the present disclosure provides a communication system, wherein the communication system includes:
an application function network element, configured to execute the information processing method as described in the first aspect; and
a non-terrestrial network (NTN) access device, configured to execute the information processing method as described in the second aspect.

A sixth aspect of the present disclosure provides a communication device, including:
a processor; and
a memory for storing instructions executable by the processor;
wherein the processor is configured to implement the information processing method described in the first aspect or the second aspect when executing the executable instructions.

A seventh aspect of the embodiments of the present disclosure provides a computer storage medium, which stores a computer executable program, and when the executable program is executed by a processor, the information processing method described in the first aspect or the second aspect is implemented.

In the technical solution provided by the embodiment of the present disclosure, capability information of an NTN access device is received by an application function network element, and the capability information is at least used to indicate the sensing capability supported by the NTN access device; in this way, the wireless sensing technology based on NTN can be integrated into the wireless communication network, thereby realizing a solution for providing sensing services based on NTN in the wireless communication network.

It is to be understood that both the foregoing general description and the following detailed description are exemplary and explanatory only and are not restrictive of the embodiments of the present disclosure.

### BRIEF DESCRIPTION OF THE DRAWINGS

The accompanying drawings herein are incorporated in and constitute a part of the specification, illustrate embodiments consistent with the present disclosure, and together with the description, serve to explain the principles of the embodiments of the present disclosure.

FIG. 1 is a schematic structural diagram of a wireless communication system according to an exemplary embodiment;

FIG. 2 is a schematic flow chart of an information processing method according to an exemplary embodiment;

FIG. 3 is a schematic flow chart of an information processing method according to an exemplary embodiment;

FIG. 4 is a schematic flow chart of an information processing method according to an exemplary embodiment;

FIG. 5 is a schematic flow chart of an information processing method according to an exemplary embodiment;

FIG. 6 is a schematic diagram of an architecture of a sensing service system based on NTN according to an exemplary embodiment;

FIG. 7 is a schematic flow chart of an information processing method according to an exemplary embodiment;

FIG. 8 is a schematic diagram showing the structure of an information processing apparatus according to an exemplary embodiment;

FIG. 9 is a schematic diagram showing the structure of an information processing apparatus according to an exemplary embodiment;

FIG. 10 is a schematic structural diagram of a communication device according to an exemplary embodiment.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The embodiments described in the following exemplary embodiments do not represent all embodiments consistent with the embodiments of the present disclosure. Instead, they are merely examples of devices and methods consistent with some aspects of the embodiments of the present disclosure.

The terms used in the embodiments of the present disclosure are only for the purpose of describing specific embodiments, and are not intended to limit the embodiments of the present disclosure. The singular forms of “a”, “said”, and “the” used in the present disclosure are also intended to include plural forms, unless the context clearly indicates other meanings. It should also be understood that the term “and/or” used in this article refers to and includes any or all possible combinations of one or more associated listed items.

It should be understood that although the terms first, second, third, etc. may be used to describe various information in the disclosed embodiments, the information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word “if” as used herein may be interpreted as “at the time of” or “when” or “in response to determining”.

The network architecture and service scenarios described in the embodiments of the present disclosure are intended to more clearly illustrate the technical solutions of the embodiments of the present disclosure, and do not constitute a limitation on the technical solutions provided by the embodiments of the present disclosure. Those skilled in the art can appreciate that with the evolution of the network architecture and the emergence of new service scenarios, the technical solutions provided by the embodiments of the present disclosure are also applicable to similar technical problems.

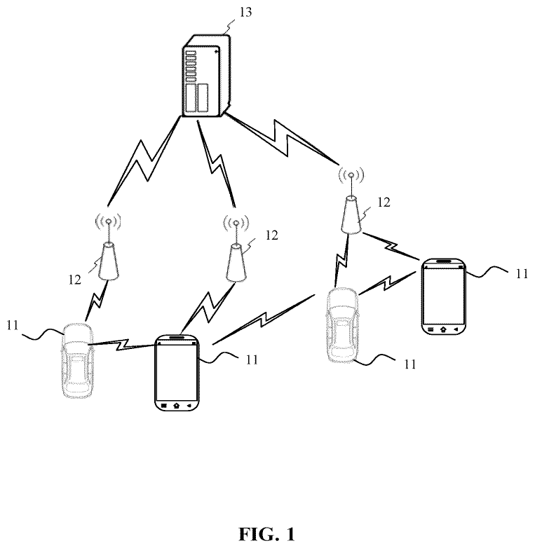

FIG. 1 is a schematic diagram of the structure of a wireless communication system according to an exemplary embodiment. To facilitate understanding of the embodiment of the present disclosure, the wireless communication system shown in FIG. 1 is first used as an example to describe in detail a wireless communication system applicable to the embodiment of the present disclosure. It should be noted that the solution in the embodiment of the present disclosure can also be applied to other wireless communication systems, and the corresponding names can also be replaced by the names of corresponding functions in other wireless communication systems.

As shown in FIG. 1, the wireless communication system is a communication system based on cellular mobile communication technology. The wireless communication system may include: a plurality of UEs 11, a plurality of access devices 12 and a core network device 13.

The UE 11 can be a device that provides voice and/or data connectivity to users. The UE 11 can communicate with one or more core networks via a radio access network (RAN). The UE 11 can be an IoT user device, such as a sensor device, a mobile phone (or a “cellular” phone), and a computer with an IoT user device, for example, a fixed, portable, pocket-sized, handheld, computer-built-in, or vehicle-mounted device. For example, a station (STA), a subscriber unit, a subscriber station, a mobile station, a mobile, a remote station, an access point, a remote user device, an access terminal, a user terminal, a user agent, a user device, or a user equipment. Alternatively, the UE 11 can also be a wearable device, a virtual reality (VR) device, an augmented reality (AR) device, or a VR/AR hybrid head-mounted device. Alternatively, the UE 11 can also be a device for an unmanned aerial vehicle. Alternatively, the UE 11 may also be a vehicle-mounted device, for example, a driving computer with wireless communication function, or a wireless user device externally connected to the driving computer. Alternatively, the UE 11 may also be a roadside device, for example, a street lamp, a signal lamp, or other roadside device with wireless communication function.

The access device 12 may be a network-side device in a wireless communication system. The access device is an entity on the network side for transmitting or receiving signals, such as a generation Node B (gNodeB). The access device may be a device for communicating with a mobile device. The access device may be used to convert received air frames to and from IP packets, as a router between a wireless terminal and the rest of the access network, wherein the rest of the access network may include an internet protocol (IP) network. The network device may also coordinate the attribute management of the air interface. The wireless communication system may be a fourth generation mobile communication technology (4G) system, also known as a long term evolution (LTE) system; or, the wireless communication system may be a 5G system, also known as a new radio (NR) system or a 5G NR system. Alternatively, the wireless communication system may be a next generation system of a 5G system. The access network in the 5G system may be referred to as NG-RAN (New Generation-Radio Access Network).

The access device 12 can be an evolved access device (eNB) adopted in a 4G system. Alternatively, the access device 12 can also be an access device (gNB) adopting a centralized distributed architecture in a 5G system. When the access device 12 adopts a centralized distributed architecture, it usually includes a centralized unit (CU) and at least two distributed units (DU). The centralized unit is provided with a protocol stack of a packet data convergence protocol (PDCP) layer, a radio link layer control protocol (RLC) layer, and a media access control (MAC) layer; the distributed unit is provided with a physical (PHY) layer protocol stack. The specific implementation method of the access device 12 is not limited in the embodiment of the present disclosure.

A wireless connection may be established between the access device 12 and the UE 11 via a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

An E2E (End to End) or D2D (device to device) connections can also be established between UEs 11, such as V2V (vehicle to vehicle) communication, V2I (vehicle to Infrastructure) communication and V2P (vehicle to pedestrian) communication in vehicle to everything (V2X) communication.

In some examples, the access device 12 may be an access device of a terrestrial network (TN), or may be an NTN device having all or part of the functions of an access network.

The NTN device may be, for example, a satellite, a high altitude platform system (HAPS) or an air to ground (ATG) device deployed in the NTN.

Exemplarily, the access device 12 may be located in a communication system integrated with a satellite communication system, and may provide connection services for the satellite, and may connect the satellite to the core network. For example, the access device 12 may be an access device with a satellite gateway function in the communication system, such as a gateway device, a ground station device, a non-terrestrial network gateway/satellite gateway (Non-terrestrial networks Gateway, NTN-Gateway), etc.

Exemplarily, the wireless communication system may further include a core network device 13. Several access devices 12 are respectively connected to the core network device 13. The core network device 13 may be an application function (AF), an access and mobility management function (AMF), a policy control function (PCF), a session management function (SMF), a user plane function (UPF), etc. The embodiment of the present disclosure does not limit the implementation form of the core network device 13. In one example, the core network device 13 is a sensing application function (SAF) network element, which is a functional network element that provides sensing services. It can be understood that in some application scenarios, the SAF network element may also be referred to as a sensing function (SF) network element.

It should be noted that the network architecture shown in FIG. 1 is only an example applicable to the embodiment of the present disclosure and does not constitute a limitation on the scope of application of the embodiment of the present disclosure.

In order to facilitate the understanding of those skilled in the art, the embodiments of the present disclosure list multiple implementation methods to clearly illustrate the technical solutions of the embodiments of the present disclosure. Of course, those skilled in the art can understand that the multiple embodiments provided by the embodiments of the present disclosure can be executed separately, or can be executed together with the methods of other embodiments of the embodiments of the present disclosure, or can be executed together with some methods in other related technologies separately or in combination; the embodiments of the present disclosure do not limit this.

In order to facilitate understanding of the technical solutions provided by the present disclosure, firstly, the terms involved in the present disclosure are exemplified.

Wireless sensing technology aims to obtain information about remote objects and their characteristics without physically contacting the remote objects themselves. By analyzing the sensing data of the objects and their surroundings, meaningful information about the objects and their characteristics can be obtained.

Radar is a widely used wireless sensing technology that uses radio waves to determine the distance (range), angle, or instantaneous linear velocity of an object. There are other sensing technologies including non-RF sensors that have been used in other areas such as time-of-flight (ToF) cameras, accelerometers, gyroscopes, and lidar.

Integrated sensing and communication in 3GPP 5G systems is providing sensing capability by using the 5G NR wireless communication system and infrastructure used for communication. The sensing information can come from RF and/or non-RF based sensors. Generally speaking, it can involve scenarios of communication-assisted sensing, such as 5G communication systems providing sensing services or sensing-assisted communication; for example, sensing information related to the communication channel or environment is used to improve the communication services of the 5G system itself; and for example, sensing information can be used to assist in radio resource management, interference mitigation, beam management, mobility, etc.

Across multiple market segments and verticals, 5G-based sensing services can benefit smart transportation, aviation, enterprises, smart cities, smart homes, factories, consumer applications, extended reality (XR), and the public sector. Mobile operators can play an important role in providing consumers with integrated sensing and communication based on 5GS, which may include 5G sensing business management and control.

In addition, operators may have a role to play in enhancing V2X-type services, particularly for infrastructure-assisted environmental sensing, infrastructure-based remote control driving, high-definition map collection and sharing, and remote control driving support.

Other examples of studying 5GS to provide communication-assisted sensing services may include:
Real-time environmental monitoring: Use wireless signals to reconstruct environmental maps, further improve positioning accuracy, and enable environmental-related applications, such as realizing a series of real-time monitoring related application detection, traffic detection, etc. such as dynamic 3D map assisted driving, pedestrian flow statistics, intrusion, etc.

Autonomous vehicles/drones: Autonomous vehicles/drones have some common functional requirements. For example, autonomous vehicles/drones should support driver attention alert (DAA) to avoid obstacles. At the same time, autonomous vehicles/drones should have the ability to monitor path information, such as selecting routes and complying with traffic regulations.

Air pollution monitoring: The quality of the received wireless signal shows different attenuation characteristics with changes in air humidity, air particulate matter (PM) concentration, carrier frequency, etc., and can be used for weather or air quality detection.

Indoor health care and intrusion detection. It can realize respiratory rate estimation, respiratory depth estimation, apnea detection, vital signs monitoring of the elderly and indoor intrusion detection.

Sensing of wireless communication channels and environments can further improve the performance of communication systems. Examples of sensing-assisted communication scenarios include:
sensing the UE's location and channel environment, to narrow the beam scanning range, and shorten the beam training time;
sensing the UE's position, speed, motion trajectory, and channel environment to perform beam prediction, to reduce the overhead of beam measurement and the delay of beam tracking; and
sensing the UE's attributes and channel environment to improve the performance of channel estimation.

A non-terrestrial network (NTN) is a communication network that uses satellites or aerial vehicles to provide communication services to user equipment (UE) based on the terrestrial communication network.

A satellite is a spaceborne vehicle carrying a bent-tube payload or a regenerative payload telecommunication launcher, typically operating in a low earth orbit (LEO) at an altitude of 300 to 2000 km, in a medium earth orbit (MEO) at an altitude of 8000 to 20000 km, or in a geostationary orbit (GEO) at an altitude of about 35786 km.

In the satellite access solution defined by 3GPP, the satellite NG-RAN is the NG-RAN that uses NR to provide satellite access to UE.

In the related art, there is no solution for NTN-based sensing services in wireless communication networks.

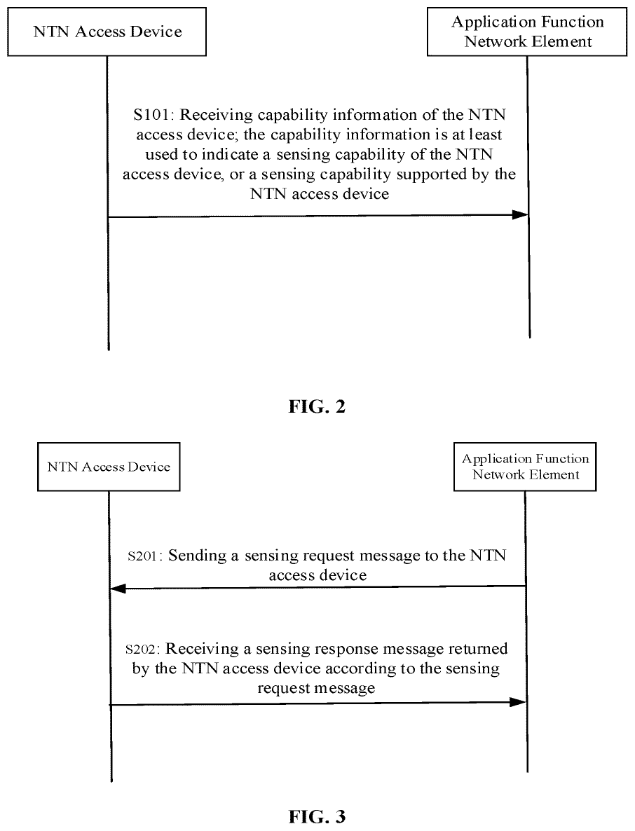

FIG. 2 is a flow chart of an information processing method according to an exemplary embodiment. The information processing method is executed by an application function network element, as shown in FIG. 2, and the method may include the following steps:
S101: Receiving capability information of an NTN access device; the capability information is at least used to indicate a sensing capability of the NTN access device, or a sensing capability supported by the NTN access device.

In one example, the NTN access device is, for example, an access network device equipped with an NTN device. In this example, the NTN device is a relay device between the NTN access device and the terminal device, and the capability information of the NTN access device may include the capability information of the NTN device equipped with the NTN access device.

In some other examples, the NTN access device is an NTN device having some or all functions of an access network device.

The NTN device is, for example, a satellite or an aircraft.

For example, the application function network element is a functional network element that provides a sensing service. For example, the application function network element may specifically be a sensing application function network element or a sensing function (SF) network element.

The application function network element can be set on other network side devices independent of the NTN access device and the core network device, or can be set in the core network device. Exemplarily, the application function network element is set on the core network device, and the application function network element is a NF (Network Function) network element, the application function network element and other NF (e.g., PCF, SMF, etc.) network elements in the core network are in the same trusted domain (e.g., the same Public Land Mobile Network (PLMN)). The application function network element can receive the capability information of the NTN access device directly from the NTN access device, or receive the capability information of the NTN access device through other NF (e.g., PCF) in the core network.

As another example, the application function network element is set on other network side devices independent of the NTN access device and the core network device. The application function network element can be an application server of a third party. Here, the third party is different from the operator. The application server of the third party and the NF network element in the core network are not in the same trusted domain. The application server of the third party needs to be connected to the core network through the NEF (Network Exposure Function) in the core network. The NEF can realize the function of the third party application server interacting with the NTN access device.

The NTN access device is an access device that supports wireless sensing in the NTN. The access device can be a base station, such as a gNB or an eNB or an access device in a subsequent evolution communication system.

Exemplarily, the sensing capability is a wireless sensing capability. Here, the NTN access device supporting the sensing capability means that the NTN access device can use the wireless sensing technology to perform data transmission.

In an embodiment, the capability information of the NTN access device is used to indicate the sensing capability of the NTN access device or the sensing capability supported by the NTN access device.

In some examples, the capability information may include at least one of the following:
indication information of the sensing capability supported by the NTN access device; and
a sensing capability type.

In some examples, the indication information may indicate at least one of the following:
a sensing type of the NTN access device or the NTN device; and
the NTN access device or the NTN device having a sensing capability.

In some examples, the sensing type of the NTN access device may be a sensing entity type or a sensing client type.

The sensing entity type indicates that the NTN access device entity or the NTN device entity has sensing capability, and the sensing client type indicates that one or more logical function modules in the NTN device or the NTN access device have sensing capability.

In some examples, the sensing capability type is used to indicate the sensing type to which the sensing capability supported by the NTN access device belongs. For example, the sensing type may include a 3GPP-based sensing capability and a non-3GPP-based sensing type.

In one example, the 3GPP-based sensing capability can be used for sensing of wireless communication channels and environments, and/or the non-3GPP-based sensing capability can be used for sensing of real-time environmental monitoring, self-driving vehicles/drones, air pollution monitoring, and/or indoor health care and intrusion detection.

For example, the capability information may indicate that the NTN access device supports a 3GPP-based sensing capability. For another example, the capability information may indicate that the NTN access device supports a non-3GPP-based sensing capability. Of course, in some cases, the capability information may indicate that the NTN access device supports both a 3GPP-based sensing capability and a non-3GPP-based sensing capability.

In another embodiment, the sensing capability supported by the NTN access device includes: a 3GPP-based sensing capability and/or a non-3GPP-based sensing capability.

In one embodiment, the 3GPP-based sensing capability includes at least one of the following:
a new radio (NR) sensing capability; and
an evolved universal terrestrial radio access network (E-UTRAN) sensing capability;
and/or, the non-3GPP based sensing capability includes at least one of the following:
a radar sensing capability;
a camera sensing capability; and
an infrared sensing capability.

The 3GPP-based sensing capability is the sensing capability that complies with the 3GPP specification, such as the NR sensing capability. When reporting the 3GPP-based sensing capability, the relevant parameters of the 3GPP-based sensing capability may be reported, such as at least one of the following parameters: sensing range, carrier frequency, accuracy, etc. The non-3GPP-based sensing capability is the sensing capability that does not comply with the 3GPP specification, and may include radar, camera and/or infrared sensing capability. When reporting the non-3GPP-based sensing capability, the relevant parameters of the non-3GPP-based sensing capability may be reported, such as at least one of the following parameters: sensing range, carrier frequency, accuracy, etc.

In some examples, in step S101, the application function network element may receive capability information of the NTN access device sent by the NTN access device.

In some examples, in step S101, the application function network element may receive a registration request message carrying the capability information of the NTN access device.

In some examples, the registration request message may be sent directly by the NTN access device to the application function network element, or may be forwarded to the application function network element via other network function network elements (e.g., UPF or PCF), which is not specifically limited in this embodiment.

For example, the registration request message may be sent by the NTN access device when the carried NTN device (satellite or aircraft, etc.) is started.

In some other examples, in step S101, the application function network element may send a request message to the NTN access device, and receive capability information of the NTN access device returned by the NTN access device in response to the request message, wherein the request message is used to request to obtain capability information of the NTN access device.

The embodiment of the present disclosure provides an information processing method, which receives capability information of an NTN access device through an application function network element, wherein the capability information is at least used to indicate the sensing capability supported by the NTN access device; in this way, the wireless sensing technology based on NTN can be integrated into the wireless communication network, thereby realizing a solution for providing sensing services based on NTN in the wireless communication network.

In an embodiment, receiving capability information of the NTN access device may include: receiving a registration request message including the capability information.

In some examples, the registration request message carries a new information element (IE), and the new information element includes the capability information.

In some examples, the registration request message may include identification information of the NTN access device in addition to the capability information of the NTN access device.

In some examples, the NTN access device may be a satellite base station, and the identification information includes at least one of the following:
a spacecraft ITU ID number (S-ITU ID);
a committee on space research identity (COSPAR ID);
an international designator (ID);
a national space science data center ID (NSSDC ID).

In some examples, the registration request message may further include movement trajectory information of the NTN access device. The movement trajectory information of the NTN access device may be used by the application function network element to determine whether the NTN access device is a target NTN access device.

The target NTN access device is a device determined by the application function network element according to the sensing requirements, and is used to perform tasks corresponding to the sensing requirements.

Optionally, the application function network element may also determine the target NTN access device according to the capability information uploaded by each NTN access device and the movement trajectory information uploaded by each NTN access device.

Of course, in other embodiments, the movement trajectory information of the NTN access device may also be carried in other messages. For example, the movement trajectory information of the NTN access device is carried in a query response message, which is used to respond to a query request message from an application function network element.

In one embodiment, the method may further include:
Receive movement trajectory information of the NTN access device, wherein the movement trajectory information of the NTN access device is used to determine to send a sensing request message to the NTN access device.

The movement trajectory information of the NTN access device can be used by the application function network element to determine whether the NTN access device is a target NTN access device. The target NTN access device is a device determined by the application function network element according to the sensing requirement, and is used to perform tasks corresponding to the sensing requirement. When the NTN access device is the target NTN access device, the application function network element determines to send a sensing request message to the NTN access device.

Optionally, the application function network element may also determine the target NTN access device according to the capability information reported by each NTN access device and the movement trajectory information reported by each NTN access device.

The movement trajectory information includes the current location of the NTN access device. Optionally, the movement trajectory information may include the location of the NTN device at different times.

The sensing requirement may be determined according to actual service needs, and the sensing requirement may include sensing services; and may also include sensing locations (or sensing areas) and time corresponding to the sensing services, etc. The sensing services may include, for example, positioning, speed measurement, distance measurement, target tracking, air pollution monitoring, and/or channel environment sensing, etc., and the embodiments of the present disclosure do not specifically limit the sensing requirements.

In some examples, the receiving the movement trajectory information of the NTN access device may include:
Receive a registration request message carrying the capability information of the NTN access device and the movement trajectory information.

In this embodiment, the registration request message may include capability information and movement trajectory information of the NTN access device.

In some other examples, the receiving the movement trajectory information of the NTN access device may include:
Receive the movement trajectory information of the NTN access device sent by the NTN access device in response to the request message from the application function network element.

In this embodiment, the application function network element can determine whether the NTN access device supports the sensing capability required to meet the sensing requirement based on the sensing requirement and the capability information of the NTN access device. If the NTN access device supports the sensing capability required to meet the sensing requirement, the application function network element can send a request message to the NTN access device. The request message can be used to obtain the movement trajectory information of the NTN access device from the NTN access device, so that the NTN access device determines whether the NTN access device is the target NTN access device that meets the sensing requirement based on the movement trajectory information of the NTN access device.

In one embodiment, the movement trajectory information may further include: ephemeris information of a satellite carrying the NTN access device.

The ephemeris information of the satellite may include values of the satellite position, velocity information, semi-major axis, ascending node and/or orbital inclination.

The satellite ephemeris information can be used to calculate the time information when the satellite covers a certain area.

In one embodiment, the method may further include:
Determine to send a sensing request message to the NTN access device according to the capability information of the NTN access device.

The application function network element may determine whether the NTN access device is a target NTN access device that meets the sensing requirement according to the capability information of the NTN access device; and when the NTN access device is the target NTN access device, determine to send a sensing request message to the NTN access device.

In this embodiment, the application function network element can determine the sensing capability required to meet the sensing requirement, compare the sensing capability required to meet the sensing requirement with the sensing capability indicated by the capability information of the NTN access device, and determine whether the NTN access device is the target NTN access device that meets the sensing requirement. When the sensing capability of the NTN access device is the sensing capability required to meet the sensing requirement, the NTN access device is the target NTN access device; when the sensing capability of the NTN access device is not the sensing capability required to meet the sensing requirement, the NTN access device is not the target NTN access device.

In one embodiment, the method may further include:
Determine to send a sensing request message to the NTN access device according to the capability information of the NTN access device and the movement trajectory information of the NTN access device.

In some examples, the application function network element can determine whether the NTN access device is a target NTN access device that meets the sensing requirements based on the sensing requirements combined with the capability information and movement trajectory information of the NTN access device; and when the NTN access device is the target NTN access device, determine to send a sensing request message to the NTN access device.

For example, when the sensing requirement is to sense a certain traffic intersection in Beijing, such as pedestrian flow statistics at traffic intersection A in the next four hours, it can be determined whether the NTN access device is the target NTN access device that meets the sensing requirement based on whether the NTN access device supports the sensing capability required to meet the sensing requirement (for example, whether the NTN access device supports radar, camera and infrared sensing) and whether the movement trajectory information of the NTN access device indicates whether the NTN access device covers the area where traffic intersection A is located in the next four hours.

In one embodiment, as shown in FIG. 3, the method may further include:
S201: Sending a sensing request message to the NTN access device.

The sensing request message is used to request the sensing data and/or sensing result corresponding to the sensing requirement.

The sensing requirement is used to determine the sensing task performed by the NTN access device, and the sensing task includes obtaining the sensing data and/or sensing result corresponding to the sensing requirement.

The sensing request message may include relevant description information of the sensing request, such as sensing requirements, etc. It is understandable that the embodiment of the present disclosure does not specifically limit the triggering generation method of the sensing request message and the content included therein.

The sensing data is measurement data obtained by the NTN access device performing sensing measurement according to the sensing request message.

Exemplarily, the sensing data may include data such as positioning, detection, imaging, and recognition of the target, for example, the target position perceived by AOA (Angle-of-Arrival) technology.

The sensing result may be a result obtained by processing the sensing data. The processing of the sensing data may include superimposing, fusing or analyzing the sensing data.

In some examples, the sensing request message may further include sensing measurement configuration information. The sensing measurement configuration information is used to indicate relevant information of the sensing signal when the NTN access device performs sensing measurement. For example, the sensing measurement configuration information may include at least one of the frequency point, frequency band, antenna configuration, beam configuration, time-frequency resource configuration, and period of the sensing signal.

In one embodiment, the application function network element can select at least one NTN access device that meets the sensing requirements based on the received capability information of each NTN access device and the movement trajectory information of each NTN device, and send a sensing request message to the selected at least one NTN access device.
S202: Receiving a sensing response message returned by the NTN access device according to the sensing request message.

The sensing response message may include the sensing data and/or sensing results corresponding to the sensing requirement, and may also include the sensing technology used by the NTN access device to perform sensing measurement according to the sensing request message.

The sensing data is measurement data obtained by the NTN access device performing sensing measurement according to the sensing request message.

Exemplarily, the sensing data may include data such as positioning, detection, imaging, and recognition of a target, for example, the position of a target perceived by AOA technology.

The sensing result may be a result obtained by processing the sensing data. The processing of the sensing data may include superimposing, fusing or analyzing the sensing data.

In the disclosed embodiment, when the NTN access device is a target NTN access device that meets the sensing requirements, the application function network element sends a sensing request message to the NTN access device and receives a sensing response message. In this way, in the wireless communication network, a solution for NTN-based sensing services can be provided according to actual sensing requirements.

In one embodiment, the method may further include:
Receive updated capability information of the NTN access device.

The sensing capability supported by the NTN access device may be updated. For example, the NTN access device may add the sensing capability that need to be supported or cancel the sensing capability that are already supported.

In some examples, the updated capability information may indicate an added sensing capability or a cancelled sensing capability of the NTN access device, or the capability update message may indicate an updated sensing capability of the NTN access device.

Exemplarily, the capability supported by the NTN access device include 3GPP-based sensing capability and non-3GPP-based sensing capability. Assume that the sensing capability supported by the NTN access device is updated, for example, the supported sensing capability that is cancelled is the non-3GPP sensing capability. One implementation is: the updated capability information indicates that the cancelled sensing capability of the NTN access device is the non-3GPP sensing capability. Another implementation is: the updated capability information indicates that the updated sensing capability of the NTN access device is the 3GPP-based sensing capability.

In another exemplary embodiment, the capability supported by the NTN access device include non-3GPP-based sensing capability. Assume that the sensing capability supported by the NTN access device is updated, for example, the supported sensing capability that is added is the 3GPP-based sensing capability. One implementation is that the updated capability information indicates that the added sensing capability of the NTN access device is the 3GPP-based sensing capability. Another implementation is that the updated capability information indicates that the updated sensing capability of the NTN access device includes: the 3GPP-based sensing capability and the non-3GPP-based sensing capability.

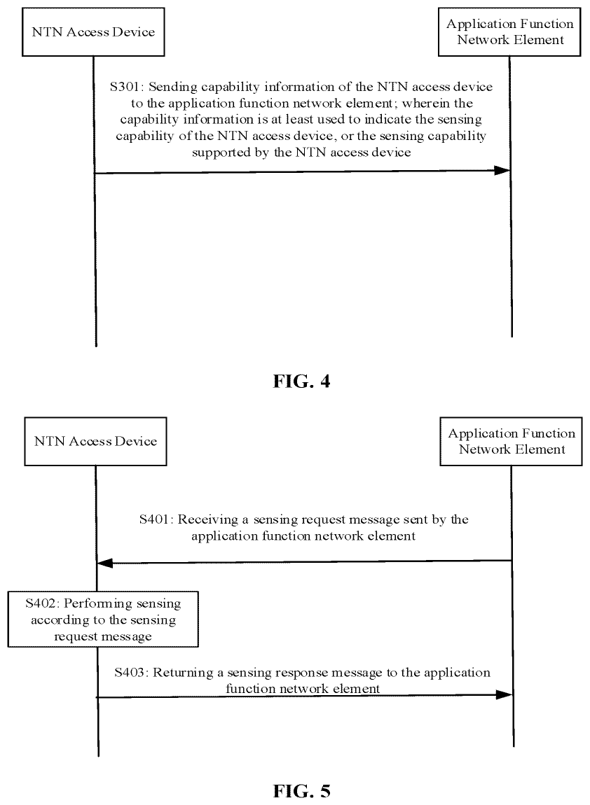

FIG. 4 is a schematic flow chart of an information processing method according to an exemplary embodiment. The information processing method is executed by a non-terrestrial network (NTN) access device, as shown in FIG. 4, and the method may include the steps of:
S301: Sending capability information of the NTN access device to an application function network element; wherein the capability information is at least used to indicate the sensing capability of the NTN access device, or the sensing capability supported by the NTN access device.

In one example, the NTN access device is, for example, an access network device equipped with an NTN device. In this example, the NTN device is a relay device between the NTN access device and the terminal device, and the capability information of the NTN access device may include the capability information of the NTN device equipped with the NTN access device.

In some other examples, the NTN access device is an NTN device having some or all functions of an access network device.

The NTN device is, for example, a satellite or an aircraft.

For example, the application function network element is a functional network element that provides a sensing service. The application function network element may specifically be a sensing application function network element or a sensing function (AF) network element.

The application function network element can be set on other network side devices independent of the NTN access device and the core network device, or can be set in the core network device. Exemplarily, the application function network element is set on the core network device, and the application function network element is a NF network element, the application function network element and other NF (e.g., PCF, SMF, etc.) network elements in the core network are in the same trusted domain (e.g., the same PLMN). The application function network element can receive the capability information of the NTN access device directly from the NTN access device, or receive the capability information of the NTN access device through other NF (e.g., PCF) in the core network.

As another example, the application function network element is set on other network side devices independent of the NTN access device and the core network device. The application function network element can be an application server of a third party. Here, the third party is different from the operator. The application server of the third party and the NF network element in the core network are not in the same trusted domain. The application server of the third party needs to be connected to the core network through the NEF (Network Exposure Function) in the core network. The NEF can realize the function of the third party application server interacting with the NTN access device.

The NTN access device is an access device that supports wireless sensing in the NTN. The access device can be a base station, such as a gNB or an eNB or an access device in a subsequent evolution communication system.

Exemplarily, the sensing capability is a wireless sensing capability. Here, the NTN access device supporting the sensing capability means that the NTN access device can use the wireless sensing technology to perform data transmission.

In an embodiment, the capability information of the NTN access device is used to indicate the sensing capability supported by the NTN access device or the sensing capability supported by the NTN device.

In some examples, the capability information may include at least one of the following:
indication information of the sensing capability supported by the NTN access device; and
a sensing capability type.

In some examples, the indication information may indicate at least one of the following:
a sensing type of the NTN access device or the NTN device; and
the NTN access device or the NTN device having a sensing capability.

In some examples, the sensing type of the NTN access device may be a sensing entity type or a sensing client type.

The sensing entity type indicates that the NTN access device entity or the NTN device entity has sensing capability, and the sensing client type indicates that one or more logical function modules in the NTN device or the NTN access device have sensing capability.

In some examples, the sensing capability type is used to indicate the sensing type to which the sensing capability supported by the NTN access device belongs. For example, the sensing type may include a 3GPP-based sensing capability and a non-3GPP-based sensing type.

In one example, the 3GPP-based sensing capability can be used for sensing of wireless communication channels and environments, and/or the non-3GPP-based sensing capability can be used for sensing of real-time environmental monitoring, self-driving vehicles/drones, air pollution monitoring, and/or indoor health care and intrusion detection.

For example, the capability information may indicate that the NTN access device supports a 3GPP-based sensing capability. For another example, the capability information may indicate that the NTN access device supports a non-3GPP-based sensing capability. Of course, in some cases, the capability information may indicate that the NTN access device supports both a 3GPP-based sensing capability and a non-3GPP-based sensing capability.

In another embodiment, the sensing capability supported by the NTN access device includes: a 3GPP-based sensing capability and/or a non-3GPP-based sensing capability.

In one embodiment, the 3GPP-based sensing capability includes at least one of the following:
a new radio (NR) sensing capability; and
an evolved universal terrestrial radio access network (E-UTRAN) sensing capability;
and/or, the non-3GPP based sensing capability includes at least one of the following:
a radar sensing capability;
a camera sensing capability; and
an infrared sensing capability.

The 3GPP-based sensing capability is the sensing capability that complies with the 3GPP specification, such as the NR sensing capability. When reporting the 3GPP-based sensing capability, the relevant parameters of the 3GPP-based sensing capability may be reported, such as at least one of the following parameters: sensing range, carrier frequency, accuracy, etc.

The non-3GPP-based sensing capability is the sensing capability that does not comply with the 3GPP specification, and may include radar, camera and/or infrared sensing capability. When reporting the non-3GPP-based sensing capability, the relevant parameters of the non-3GPP-based sensing capability may be reported, such as at least one of the following parameters: sensing range, carrier frequency, accuracy, etc.

In some examples, in step S301, the NTN access device may send a registration request message carrying the capability information of the NTN access device to the application function network element.

In some examples, the registration request message may be sent directly by the NTN access device to the application function network element, or may be forwarded to the application function network element via other network function network elements (e.g., UPF or PCF), which is not specifically limited in this embodiment.

For example, the registration request message may be sent by the NTN access device when the carried NTN device (satellite or aircraft, etc.) is started.

In some other examples, in step S301, the NTN access device may send the message of the capability of the NTN access device to the application function network element according to the request message sent by the application function network element, wherein the request message is used to request to obtain capability information of the NTN access device.

The embodiment of the present disclosure provides an information processing method, which sends the capability information of the NTN access device to the application function network element through the NTN access device, wherein the capability information is at least used to indicate the sensing capability supported by the NTN access device; in this way, the wireless sensing technology based on NTN can be integrated into the wireless communication network, thereby realizing a solution for providing sensing services based on NTN in the wireless communication network.

In an embodiment, sending the capability information of the NTN access device to the application function network element may include:
sending a registration request message including the capability information to the application function network element.

In some examples, the registration request message carries a new information element (IE), and the new information element includes the capability information.

In some examples, the registration request message may include identification information of the NTN access device in addition to the capability information of the NTN access device.

In some examples, the NTN access device may be a satellite base station, and the identification information includes at least one of the following:
a spacecraft ITU ID number (S-ITU ID);
a committee on space research identity (COSPAR ID);
an international designator (ID);
a national space science data center ID (NSSDC ID).

In some examples, the registration request message may further include movement trajectory information of the NTN access device. The movement trajectory information of the NTN access device may be used by the application function network element to determine whether the NTN access device is a target NTN access device.

The target NTN access device is a device determined by the application function network element according to the sensing requirements, and is used to perform tasks corresponding to the sensing requirements.

Optionally, the application function network element may also determine the target NTN access device according to the capability information uploaded by each NTN access device and the movement trajectory information uploaded by each NTN access device.

Of course, in other embodiments, the movement trajectory information of the NTN access device may also be carried in other messages. For example, the movement trajectory information of the NTN access device is carried in a query response message, which is used to respond to a query request message from an application function network element.

In one embodiment, the method may further include:
send movement trajectory information of the NTN access device.

The movement trajectory information of the NTN access device is used for the application function network element to determine to send a sensing request message to the NTN access device.

The movement trajectory information of the NTN access device can be used by the application function network element to determine whether the NTN access device is a target NTN access device. The target NTN access device is a device determined by the application function network element according to the sensing requirement, and is used to perform tasks corresponding to the sensing requirement. When the NTN access device is the target NTN access device, the application function network element determines to send a sensing request message to the NTN access device.

The movement trajectory information includes the current location of the NTN access device. Optionally, the movement trajectory information may include the location of the NTN device at different times.

The sensing requirement may be determined according to actual service needs, and the sensing requirement may include sensing services; and may also include sensing locations (or sensing areas) and time corresponding to the sensing services, etc. The sensing services may include, for example, positioning, speed measurement, distance measurement, target tracking, air pollution monitoring, and/or channel environment sensing, etc., and the embodiments of the present disclosure do not specifically limit the sensing requirements.

In some examples, the sending the movement trajectory information of the NTN access device may include:
Send a registration request message carrying the capability information of the NTN access device and the movement trajectory information.

In this embodiment, the registration request message may include capability information and movement trajectory information of the NTN access device.

In some examples, the sending the movement trajectory information of the NTN access device may include:
Send the movement trajectory information of the NTN access device to the application function network element in response to the request message from the application function network element.

In this embodiment, the application function network element can determine whether the NTN access device supports the sensing capability required to meet the sensing requirement based on the sensing requirement and the capability information of the NTN access device. If the NTN access device supports the sensing capability required to meet the sensing requirement, the application function network element can send a request message to the NTN access device. The request message can be used to obtain the movement trajectory information of the NTN access device from the NTN access device, so that the NTN access device determines whether the NTN access device is the target NTN access device that meets the sensing requirement based on the movement trajectory information of the NTN access device.

In one embodiment, the movement trajectory information includes: ephemeris information of a satellite carrying the NTN access device.

The ephemeris information of the satellite may include values of the satellite position, velocity information, semi-major axis, ascending node and/or orbital inclination.

The satellite ephemeris information can be used to calculate the time information when the satellite covers a certain area.

In one embodiment, as shown in FIG. 5, the method may further include:
S401: Receiving a sensing request message sent by the application function network element;
S402: Performing sensing according to the sensing request message; and
S403: Returning a sensing response message to the application function network element.

The sensing request message is used to request the sensing data and/or sensing result corresponding to the sensing requirement.

The sensing request message may include relevant description information of the sensing request, such as sensing requirements, etc. It is understandable that the embodiment of the present disclosure does not specifically limit the triggering generation method of the sensing request message and the content included therein.

The sensing data is measurement data obtained by the NTN access device performing sensing measurement according to the sensing request message.

Exemplarily, the sensing service data may include data such as positioning, detection, imaging, and recognition of the target, for example, the target position perceived by AOA technology.

The sensing result may be a result obtained by processing the sensing data. The processing of the sensing data may include superimposing, fusing or analyzing the sensing data.

In some examples, the sensing request message may further include sensing measurement configuration information. The sensing measurement configuration information is used for the NTN access device to configure relevant information of the sensing signal when performing sensing measurement. For example, the sensing measurement configuration information may include at least one of the frequency point, frequency band, antenna configuration, beam configuration, time-frequency resource configuration, and period of the sensing signal.

In some examples, the sensing response message may include the sensing data and/or sensing results corresponding to the sensing requirement, and may also include the sensing technology used by the NTN access device to perform sensing measurement according to the sensing request message.

In the disclosed embodiment, the NTN access device performs sensing according to a sensing request message sent by the application function network element, and returns a sensing response message to the application function network element. In this way, in the wireless communication network, a solution for NTN-based sensing services can be provided according to actual sensing requirements.

In one embodiment, the method further includes:
Send a capability update message of the NTN access device to the application function network element.

The capability update message is used to update the capability information of the NTN access device.

The sensing capability supported by the NTN access device may be updated. For example, the NTN access device may add the sensing capability that need to be supported or cancel the sensing capability that are already supported.

In some examples, the updated capability information may indicate an added sensing capability or a cancelled sensing capability of the NTN access device, or the capability update message may indicate an updated sensing capability of the NTN access device.

Exemplarily, the capability supported by the NTN access device include 3GPP-based sensing capability and non-3GPP-based sensing capability. Assume that the sensing capability supported by the NTN access device is updated, for example, the supported sensing capability that is cancelled is the non-3GPP sensing capability. One implementation is: the updated capability information indicates that the cancelled sensing capability of the NTN access device is the non-3GPP sensing capability. Another implementation is: the updated capability information indicates that the updated sensing capability of the NTN access device is the 3GPP-based sensing capability.

In another exemplary embodiment, the capability supported by the NTN access device include non-3GPP-based sensing capability. Assume that the sensing capability supported by the NTN access device are updated, for example, the sensing capability added to the support is the 3GPP-based sensing capability. One implementation is that the updated capability information indicates that the sensing capability added by the NTN access device is the 3GPP-based sensing capability. Another implementation is that the updated capability information indicates that the updated sensing capability of the NTN access device includes: the 3GPP-based sensing capability and the non-3GPP-based sensing capability.

The following uses a satellite NR-RAN as an example to further illustrate the technical solution provided by the embodiment of the present disclosure.

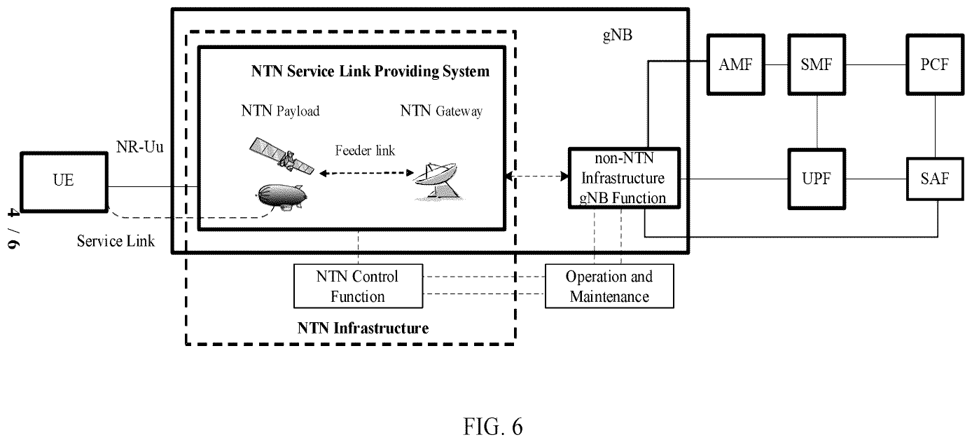

Referring to FIG. 6, which is a schematic diagram of the architecture of an NTN-based sensing service system provided in an embodiment of the present disclosure. As shown in FIG. 6, the satellite carries a payload with access network equipment functions. The user equipment (UE) and the access network equipment (gNB) are connected through the NR-UU interface, and a feeder link is established between the satellite and the NTN gateway. The NTN infrastructure can establish wireless feedback links with the AMF, UPF, and sensing application function (SAF) respectively via the non-NTN infrastructure gNB function. In addition, the SAF can be connected to the PCF, and can also be connected to the SMF connected to the AMF via the UPF.

The sensing application function can obtain information about the environment and/or objects perceived by satellites with sensing capability.

The interface between the non-NTN infrastructure gNB function and the SAF can be based on the IP connection configured by the operator. For example, if the gNB is configured with IP address A and the SAF is configured with IP address B, then an IP connection can be established from the gNB (IP A) to the SAF (IP B) using, for example, the TCP/HTTP protocol.

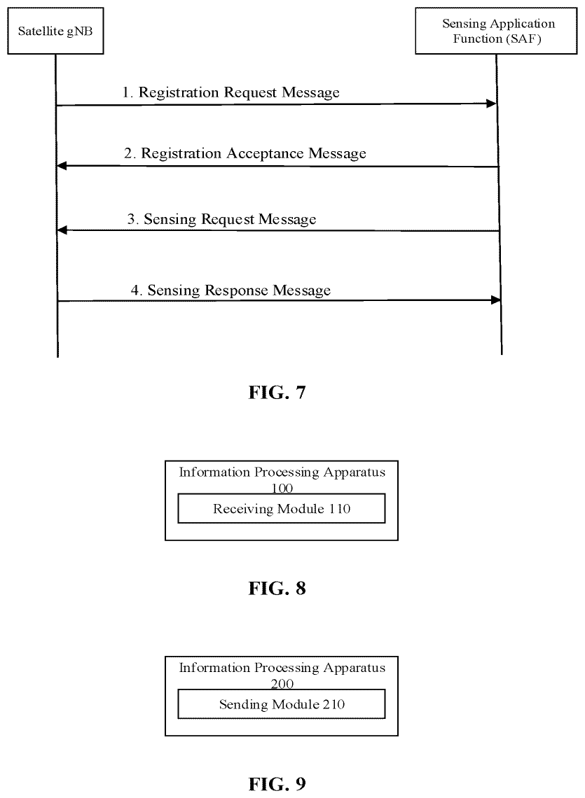

Referring to FIG. 7, an embodiment of the present disclosure provides an information processing method, which may include the following steps:
1: The satellite-gNB sends a registration request message to the SAF; the registration request message carries registration information.

The satellite gNB starts the registration process according to the pre-configured SAF IP address and sends a registration request message to the SAF.

Here, the satellite gNB can act as an NR transmitter and receiver; the satellite gNB can support 3GPP NR sensing capability and non-3GPP sensing capability (such as radar, camera, and infrared). The SAF is authorized to enable sensing services.

The registration information may include at least one of the following:
The satellite gNB ID (e.g. S-ITU ID, COSPAR ID and/or NSSDC ID), sensing entity type or sensing client type, and indication of satellites with sensing capability;
The satellite ephemeris; and
The satellite-supported sensing capability.

The NTN access device is a satellite gNB. The sensing entity type indicates that the satellite gNB entity or the satellite entity has sensing capability. The sensing client type indicates that the satellite gNB or one or more logical functional modules of the satellite have sensing capability.

The satellite indication with sensing capability indicates that the satellite gNB or the satellite has sensing capability.

The sensing capability supported by the satellite may include: 3GPP NR sensing capability (e.g., sensing range, frequency, accuracy) and/or non-3GPP sensing capability (e.g., radar, camera, and infrared with sensing range and accuracy).
2: the SAF sends a registration acceptance message to the satellite gNB.
3: the SAF sends a sensing request message to the satellite gNB.

The SAF selects a sensing satellite that can meet the sensing requirements based on the received registration information and sensing requirements (such as service type, sensing location/area, and/or time, etc.), and sends a sensing request message to the satellite.
4: The satellite gNB returns a sensing response message to the SAF.

The satellite performs sensing according to the SAF's sensing request message and reports the sensing data and/or sensing results to the SAF in a sensing response message, which includes the technology used to obtain the sensing data and/or sensing results: 3GPP NR and/or Non-3GPP (radar, camera and/or infrared, etc.).

Here, the sensing result may be an analysis result obtained based on the sensing data.

In the above information processing method, by providing the sensing capability and satellite ephemeris of the satellite gNB to the sensing application function, in the wireless communication network, the satellite gNB can report the sensing data and/or sensing results to the SAF to support the sensing service.

FIG. 8 is a structural diagram of an information processing apparatus according to an exemplary embodiment. The information processing apparatus is applied to an application function network element. As shown in FIG. 8, the information processing apparatus 100 may include:
a receiving module 110, configured to receive capability information of a non-terrestrial network NTN access device; wherein the capability information is at least used to indicate a sensing capability supported by the NTN access device.

In one embodiment, the receiving module 110 is configured to:
Receive a registration request message including the capability information.

In one embodiment, the receiving module 110 is further configured to:
Receive movement trajectory information of the NTN access device, wherein the movement trajectory information of the NTN access device is used to determine to send a sensing request message to the NTN access device.

In one embodiment, the apparatus further includes:
a determination module, configured to determine to send a sensing request message to the NTN access device according to the movement trajectory information of the NTN access device and the capability information of the NTN access device.

In one embodiment, the movement trajectory information includes: ephemeris information of a satellite carrying the NTN access device.

In one embodiment, the apparatus further includes:
a sending module, configured to send a sensing request message to the NTN access device; and
the receiving module 110 is further configured to receive a sensing response message returned by the NTN access device according to the sensing request message.

In one embodiment, the receiving module 110 is configured to:
Receive updated capability information of the NTN access device.

In one embodiment, the sensing capability supported by the NTN access device includes: sensing capability based on the third generation partnership project 3GPP and/or sensing capability based on non-3GPP.

In one embodiment, the 3GPP-based sensing capability includes at least one of the following:
the new radio (NR) sensing capability; and
The evolved universal terrestrial radio access network (E-UTRAN) sensing capability;
and/or, the non-3GPP based sensing capability includes at least one of the following:
the radar sensing capability;
the camera sensing capability; and
the infrared sensing capability.

FIG. 9 is a structural diagram of an information processing apparatus according to an exemplary embodiment. The information processing apparatus is applied to NTN access device. As shown in FIG. 9, the information processing apparatus 200 may include:
a sending module 210, configured to send capability information of the NTN access device to the application function network element; wherein the capability information is at least used to indicate the sensing capability supported by the NTN access device.

In one embodiment, the sending module 210 is configured to:
Send a registration request message including the capability information to the application function network element.

In one embodiment, the sending module 210 is further configured to:
Send movement trajectory information of the NTN access device to the application function network element.

In one embodiment, the movement trajectory information includes: ephemeris information of a satellite carrying the NTN access device.

In one embodiment, the apparatus further includes:
a receiving module, configured to receive a sensing request message sent by the application function network element; and
a sensing module, configured to perform sensing according to the sensing request message;
the sending module 210 is further configured to return a sensing response message to the application function network element.

In one embodiment, the sending module 210 is further configured to:
Send updated capability information of the NTN access device to the application function network element.

In one embodiment, the sensing capability supported by the NTN access device includes: the sensing capability based on the third generation partnership project 3GPP and/or the sensing capability based on non-3GPP.

The embodiment of the present disclosure provides a communication system, which may include: an NTN access device and an application function network element;
The NTN access device is used to send capability information of the NTN access device to the application function network element; wherein the capability information is at least used to indicate the sensing capability supported by the NTN access device; and
The application function network element is used to receive capability information of the NTN access device; the capability information is at least used to indicate the sensing capability supported by the NTN access device.

In one embodiment, the application function network element is used to:
Receive a registration request message including the capability information.

In one embodiment, the registration request message further includes movement trajectory information of the NTN access device, wherein the movement trajectory information of the NTN access device is used to determine to send a sensing request message to the NTN access device.

In one embodiment, the application function network element is used to:
Determine to send a sensing request message to the NTN access device according to the movement trajectory information and the capability information of the NTN access device.

In one embodiment, the movement trajectory information includes: ephemeris information of a satellite carrying the NTN access device.

In one embodiment, the application function network element is used to:
Send a sensing request message to the NTN access device; and
Receive a sensing response message returned by the NTN access device according to the sensing request message.

In one embodiment, the application function network element is used to:
Receive updated capability information of the NTN access device.

In one embodiment, the NTN access device is used to:
Send a registration request message including the capability information to the application function network element.

In one embodiment, the NTN access device is used to:
Receive a sensing request message sent by the application function network element; and
Perform sensing and return a sensing response message to the application function network element according to the sensing request message.

In one embodiment, the NTN access device is used to:
Send updated capability information of the NTN access device to the application function network element.

In one embodiment, the sensing capability supported by the NTN access device includes: the sensing capability based on the third generation partnership project 3GPP and/or the sensing capability based on non-3GPP.

In one embodiment, the 3GPP-based sensing capability includes at least one of the following:
the new radio (NR) sensing capability; and
the evolved universal terrestrial radio access network (E-UTRAN) sensing capability;
and/or, the non-3GPP based sensing capability includes at least one of the following:
the radar sensing capability;
the camera sensing capability; and
the infrared sensing capability.

The present disclosure provides a communication device, including:
a processor; and
a memory for storing instructions executable by the processor;
wherein the processor is configured to implement the information processing method provided by any of the aforementioned technical solutions when running the executable instructions.

The processor may include various types of storage media, which are non-transitory computer storage media that can continue to retain information stored thereon after the communication device loses power.

Here, the communication device may include but is not limited to at least one of: the NTN access device and the application function network element.

The processor may be connected to the memory via a bus or the like, and is used to read an executable program stored in the memory, for example, at least one of the information processing methods of any of the above embodiments.

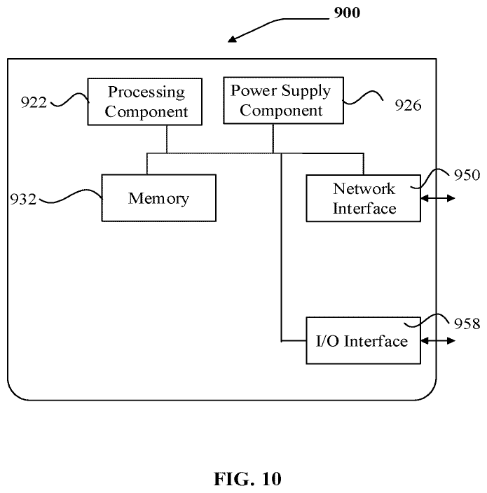

As shown in FIG. 10, an embodiment of the present disclosure shows a structure of a communication device. Referring to FIG. 10, the communication device 900 includes a processing component 922, which further includes one or more processors, and a memory resource represented by a memory 932 for storing instructions that can be executed by the processing component 922, such as an application. The application stored in the memory 932 may include one or more modules, each corresponding to a set of instructions. In addition, the processing component 922 is configured to execute instructions to perform the information processing method of the aforementioned embodiment.

The communication device 900 may also include a power supply component 926 configured to perform power management of the network device 900, a wired or wireless network interface 950 configured to connect the network device 900 to a network, and an input/output (I/O) interface 958. The network device 900 may operate based on an operating system stored in the memory 932, such as Windows Server™, Mac OS X™, Unix™, Linux™, FreeBSD™ or the like.

In the embodiments of the present disclosure, there is also provided a non-transitory computer-readable storage medium including instructions, such as a memory including instructions, and the instructions can be executed by a processor of a communication device to generate the above-mentioned information processing method. For example, the non-transitory computer-readable storage medium can be a ROM, a random access memory (RAM), a CD-ROM, a magnetic tape, a floppy disk, an optical data storage device, etc.

Those skilled in the art will readily appreciate other embodiments of the present disclosure after considering the specification and practicing the invention disclosed herein. The present disclosure is intended to cover any variations, uses or adaptations of the present disclosure that follow the general principles of the present disclosure and include common knowledge or customary techniques in the art that are not disclosed in the present disclosure. The description and examples are to be considered exemplary only, and the true scope and spirit of the present disclosure are indicated by the following claims.

It should be understood that the present disclosure is not limited to the exact structures that have been described above and shown in the drawings, and that various modifications and changes may be made without departing from the scope thereof. The scope of the present disclosure is limited only by the appended claims.

What is claimed is:

1. An information processing method, executed by an application function network element, and comprising:
receiving capability information of a non-terrestrial network (NTN) access device, wherein the capability information is at least used to indicate a sensing capability supported by the NTN access device.

2. The method according to claim 1, wherein the receiving capability information of the non-terrestrial network (NTN)access device comprises:
receiving a registration request message comprising the capability information.

3. The method according to claim 1 or 2, wherein the method further comprises:
receiving movement trajectory information of the NTN access device, wherein the movement trajectory information of the NTN access device is used to determine to send a sensing request message to the NTN access device.

4. The method according to claim 3, wherein the method further comprises:
determining to send the sensing request message to the NTN access device according to the movement trajectory information of the NTN access device and the capability information of the NTN access device.

5. The method according to claim 3 or 4, wherein the movement trajectory information comprises: ephemeris information of a satellite carrying the NTN access device.

6. The method according to any one of claims 3 to 5, wherein the method further comprises:
sending the sensing request message to the NTN access device; and
receiving a sensing response message returned by the NTN access device according to the sensing request message.

7. The method according to any one of claims 1 to 6, wherein the method further comprises:
receiving updated capability information of the NTN access device.

8. The method according to any one of claims 1 to 7, wherein the sensing capability supported by the NTN access device comprises: the sensing capability based on the 3rd generation partnership project (3GPP) and/or the sensing capability based on non-3GPP.

9. The method according to claim 8, wherein the sensing capability based on the 3rd generation partnership project (3GPP) comprises at least one of the following:
a new radio (NR) sensing capability; or
an evolved universal terrestrial radio access network (E-UTRAN) sensing capability;
and/or, wherein the non-3GPP based sensing capability comprises at least one of the following:
a radar sensing capability;
a camera sensing capability; or
an infrared sensing capability.

10. An information processing method, executed by a non-terrestrial network (NTN) access device, and comprising:
sending capability information of the NTN access device to an application function network element, wherein the capability information is at least used to indicate a sensing capability supported by the NTN access device.

11. The method according to claim 10, wherein the sending capability information of the NTN access device to the application function network element comprises:
sending a registration request message comprising the capability information to the application function network element.

12. The method according to claim 10 or 11, wherein the method further comprises:
sending movement trajectory information of the NTN access device to the application function network element.

13. The method according to claim 12, wherein the movement trajectory information of the NTN access device is used to determine to send a sensing request message to the NTN access device.

14. The method according to claim 12 or 13, wherein the method further comprises:
receiving a sensing request message sent by the NTN access device; and
performing sensing according to the sensing request message, and returning a sensing response message to the application function network element.

15. The method according to anyone of claims 10 to 14, wherein the method further comprises:
sending updated capability information of the NTN access device to the application function network element.

16. The method according to any one of claims 10 to 15, wherein the sensing capability supported by the NTN access device comprises: the sensing capability based on the 3rd generation partnership project (3GPP) and/or the sensing capability based on non-3GPP.

17. The method according to claim 16, wherein the sensing capability based on the 3rd generation partnership project (3GPP) comprises at least one of the following:
a new radio (NR) sensing capability; or
an evolved universal terrestrial radio access network (E-UTRAN) sensing capability;
and/or, wherein the non-3GPP based sensing capability comprises at least one of the following:
a radar sensing capability;
a camera sensing capability; or
an infrared sensing capability.

18. An information processing apparatus, applied to an application function network element, and comprising:
a receiving module, configured to receive capability information of a non-terrestrial network (NTN) access device, wherein the capability information is at least used to indicate a sensing capability supported by the NTN access device.

19. An information processing apparatus, wherein the apparatus is applied to a non-terrestrial network (NTN) access device, the apparatus comprising:
a sending module, configured to send capability information of the NTN access device to an application function network element, wherein the capability information is at least used to indicate a sensing capability supported by the NTN access device.

20. A communication system, wherein the communication system comprises:
an application function network element, configured to execute the information processing method according to any one of claims 1 to 9; and
a non-terrestrial network (NTN) access device, configured to execute the information processing method according to any one of claims 10 to 17.

21. A communication device, wherein the communication device comprises:
a processor; and
a memory for storing instructions executable by the processor;
wherein the processor is configured to: implement the information processing method according to any one of claims 1 to 17 when running the executable instructions.

22. A computer storage medium, wherein the computer storage medium stores a computer executable program, and when the executable program is executed by a processor, the information processing method according to any one of claims 1 to 17 is implemented.
